(19) United States
(12) Patent Application Publication
(10) Pub. No.: US 2025/0369261 A1
(43) Pub. Date: Dec. 4, 2025

(54) MOTOR VEHICLE LOCKING DEVICE

(71) Applicant: Kiekert Aktiengesellschaft, Heiligenhaus (DE)

(72) Inventors: Aleš KEJDANA, Prelouc (CZ); Jan SUK, Pardubice (CZ)

(73) Assignee: Kiekert Aktiengesellschaft, Heiligenhaus (DE)

(21) Appl. No.: 18/876,359

(22) PCT Filed: May 12, 2023
(86) PCT No.: PCT/DE2023/100348

§ 371 Date: Dec. 18, 2024

(30) Foreign Application Priority Data
Jun. 22, 2022 (DE) 10 2022 115 499.8

(51) Int. Cl. E05B 77/04; E05B 83/24; E05B 85/02

(52) U.S. Cl. CPC E05B 77/04; E05B 83/243; E05B 85/02

(57) ABSTRACT

The invention relates to a motor vehicle locking device, in particular a motor vehicle lock and preferably a motor vehicle bonnet lock. The motor vehicle locking device is equipped with a locking mechanism (2, 3) which consists substantially of a rotary latch (2) and a pawl (3). Furthermore, a lock case (7) is provided for mounting the locking mechanism (2, 3). The lock case (7) is designed to be deformable in response to forces (F) that are acting thereon and those caused by acceleration, for example in the event of a crash. According to the invention, above a certain force (F) the deformable lock case (7) rests against the locking mechanism (2, 3) in order to increase a common section modulus.

The invention relates to a motor vehicle locking mechanism, in particular a motor vehicle lock and preferably a motor vehicle bonnet lock, with a locking mechanism consisting substantially of a rotary latch and a pawl, and with a lock case for mounting the locking mechanism, wherein the lock case is designed to be deformable in response to attacking and acceleration-induced forces, for example in the event of a crash.

In the event of a crash or an accident scenario, large accelerations or decelerations are applied to a motor vehicle and consequently also to the associated motor vehicle locking device, which correspond to values of several tens of g with g the acceleration due to gravity. For this reason, both the lock case and the locking mechanism, consisting substantially of the rotary latch and pawl, are generally made of metal, in particular high-strength steel. This is because the motor vehicle locking device must also ensure that doors, hoods or even flaps secured against a car body remain closed in the event of an accident, for example, in order to prevent people from being ejected from the motor vehicle. In addition, it is only possible to ensure that safety devices such as side airbags, side impact protection, etc. are installed when the motor vehicle doors are closed. Effect to protect the vehicle occupants.

For this reason, the generic prior art according to EP 2 888 425 B1 proceeds in such a manner that the axes of rotation of the rotary latch on the one hand and the pawl on the other hand are additionally equipped with a reinforcing plate arranged at a distance from the lock case and coupling them. In this manner, particularly large forces can be absorbed because the lock case in conjunction with the reinforcement plate provides a supporting structure with an overall rectangular cross-section. This has basically proven itself, but is complex in terms of design and production.

In a comparable motor vehicle door lock according to DE 10 2019 108 967 A1, the lock case is equipped with at least one connecting web, which protrudes into a receptacle of an additionally provided reinforcing element. The connecting bar engages in the surrounding receptacle with a predetermined amount of play in order to limit any deformation.

Alternatively, an additional component such as a “structural rivet” can be used, which is permanently mounted on the lock case. This additional component can be used to absorb deformations of a pawl during an accident, as explained in more detail in DE 10 2016 218 229 A1.

The state of the art has proven itself in principle, but is structurally complex and requires additional manufacturing and processing steps due to the additional reinforcing or connecting plates and reinforcing elements. The invention as a whole seeks to remedy this.

The invention is based on the technical problem of further developing such a motor vehicle locking device in such a manner that high forces acting on it, for example in the event of a crash, can be controlled easily and cost-effectively without additional design effort.

To solve this technical problem, a generic motor vehicle locking mechanism within the scope of the invention is characterized by the fact that, above a certain force, the deformable lock case is applied to the locking mechanism to increase a common moment of resistance.

First of all, the invention is generally based on the realization that, for example, forces associated with a crash and acting on the motor vehicle locking mechanism can typically lead to the locking mechanism being deformed. This can be attributed to the fact that in the closed state of the associated motor vehicle door or motor vehicle hood or motor vehicle flap, a locking bolt attached to the door, hood or flap in question is held in the closed position of the locking mechanism by the rotary latch, wherein the rotary latch is in turn latched by means of the pawl. If forces caused by an accident now act on the locking mechanism in question in its closed position, these forces typically ensure that the rotary latch in particular and the locking mechanism as a whole are deformed via the locking bolt. In most cases, the applied forces result in tearing forces that act on the associated bearing pins, with the help of which the rotary latch or the pawl are mounted on or in the lock case.

The anchoring of the bearing pins counteracts the forces with a certain moment of resistance, which is structurally provided by the locking mechanism. Within the scope of the invention, this resisting torque, which is opposed by the locking mechanism to the acting tearing forces, can now be increased by the fact that, from a certain force (typically associated with the crash), the deformable lock case is applied to the locking mechanism to increase the joint resisting torque. This means that the applied force not only deforms the locking mechanism or causes tearing forces to act on the bearing pins, but above a certain applied force the lock case is also deformed.

According to the invention, the deformation of the lock case is adjusted so that the deformed lock case rests against the locking mechanism. In this manner, the joint moment of resistance is increased, which results from the moment of resistance of the locking mechanism plus that of the lock case. This means that the motor vehicle locking mechanism according to the invention can absorb and control forces that are significantly higher than those that can be absorbed by the locking mechanism alone. This can be attributed to the combinatorial effect of the locking mechanism including the lock case in the event of a crash.

In normal operation, the locking mechanism and the lock case are actually spaced apart from one another, because otherwise frictionless actuation of the locking mechanism would not be possible during pivoting movements relative to the lock case around the respective bearing arbor. However, in the event of a crash or when high acceleration or deceleration forces are applied, the lock case is deformed on the one hand and, from a certain force threshold, the lock case is also deformed in such a way that the deformation causes the lock case to overcome the distance between it and the locking mechanism during normal operation and rest against the locking mechanism. This provides the locking mechanism with additional reinforcement and the locking mechanism and lock case work together, resulting in the desired increase in the now observed joint moment of resistance of the locking mechanism and lock case. All this is achieved without additional design measures such as reinforcing elements, reinforcing plates, etc., simply by adjusting the deformation of the lock case so that it (the deformation) is so large above a certain threshold for the applied force that, for example, associated bulges in the lock case reach the locking mechanism and thus stiffen it. These are the main advantages.

In an advantageous embodiment, the design is also such that the locking mechanism can be deformed up to a first force limit and, together with the lock case, which can also be deformed, reaches a higher second force limit. The first force limit can reach values of approx. 4 kN to 6 kN and preferably 5 kN. In contrast, the second higher force limit corresponds to values of more than 9 kN to approx. 12 kN and preferably to values of approx. 10.5 kN.

In any case, it is clear that the locking mechanism is initially deformed until the first force limit is reached and is able to absorb the forces applied in the event of a crash, for example. At even higher forces, the lock case is deformed to such an extent that it rests against the locking mechanism and additionally stiffens it. As a result, the combination of the deformed lock case and the stiffened locking mechanism can now absorb forces up to the second force limit. This means that practically all crash situations and the associated crash forces can be controlled without special design measures, and without unintentional door opening, flap opening or hood opening.

In fact, opening the hood of a motor vehicle in the event of a crash, for example, should be avoided at all costs for several reasons. First of all, the hood is needed to act as a “crumple zone” together with other structural elements of the bodywork in the event of a frontal crash. In addition, an uncontrolled opening hood can not only impair a driver's view in the event of a crash, but may even tip over and destroy a windscreen, posing an additional risk to vehicle occupants. In this respect, adopting and maintaining the closed position in the event of a crash is particularly important, especially for hoods. The same applies to tailgates and side doors anyway.

Furthermore, the design is also such that the joint deformability of the locking mechanism in contact with the lock case and the lock case corresponds to an increase in the force that can be absorbed of at least 50% and preferably 70% or more compared to the force absorbed by the locking mechanism alone. In other words, the combinatorial effect of the deformed lock case in conjunction with the locking mechanism to stiffen it means that the forces that can be absorbed by the locking device according to the invention can be increased by at least 50% and preferably by 70% compared to the situation where the lock case is not used for additional stiffening of the locking mechanism. In this respect, the lock case assumes the function of additional reinforcing elements, as described in the prior art and obsolete according to the invention, due to its deformation in the event of a crash.

In addition, the design is such that the lock case and the rotary latch overlap to increase the joint moment of resistance, so that the deformed lock case contacts the rotary latch and stiffens it when a certain force threshold is exceeded and thus after a corresponding deformation. This results in the desired increase in the section modulus at this point, because the rotary latch has caught the locking bolt, so that tearing forces introduced into the rotary latch via the locking bolt meet the section modulus, which is now increased by the deformed lock plate in contact with it.

In a further advantageous embodiment, the lock case is equipped with at least one guide element for mutual guidance relative to the rotary latch in the event of deformation. In other words, the guide element ensures that the deforming lock case is guided in relation to the rotary latch during the deformation process and that the desired contact with the rotary latch is achieved. For this purpose and for cost reasons, it has proven to be particularly advantageous if the guide element is designed as a folded edge on the typically metallic lock case. As a rule, the lock case and the locking mechanism are made of high-strength steel.

It has also proven to be a good idea for the guide element to overlap a stop leg of the rotary latch. In fact, the rotary latch usually has the relevant stop leg and a catch leg, which are opposite one another and describe an inlet mouth for the locking bolt between them.

Finally, it has proven to be particularly advantageous if the lock case has an L-shaped cross-section with a long L-leg and a short L-leg. The long L-leg is generally designed in such a way that it forms a deformable impact plate running transversely to the longitudinal extension of an associated vehicle. In contrast, the short L-leg describes a mounting plate coupled, for example, to a cross member of the motor vehicle. This means that the short L-leg or the mounting plate realized at this point usually ensures that the lock case is fixed to the cross beam of the motor vehicle. In contrast, the long L-leg and the deformable impact plate realized at this point act as a stiffener that can be applied to the locking mechanism in the event of a crash. For this purpose, the locking mechanism is usually mounted on the impact plate in question, while the mounting plate ensures that it is fixed to the cross beam of the motor vehicle.

The result is a motor vehicle locking device that is able to absorb and control the forces that occur in a crash in a remarkably simple manner. All this is achieved without the need for additional reinforcement plates or reinforcing elements, simply by the fact that in the event of a crash, the deformed lock case is placed against the locking mechanism to reinforce it. These are the main advantages.

The invention is explained in greater detail below with reference to drawings which show only one exemplary embodiment. In the drawings:

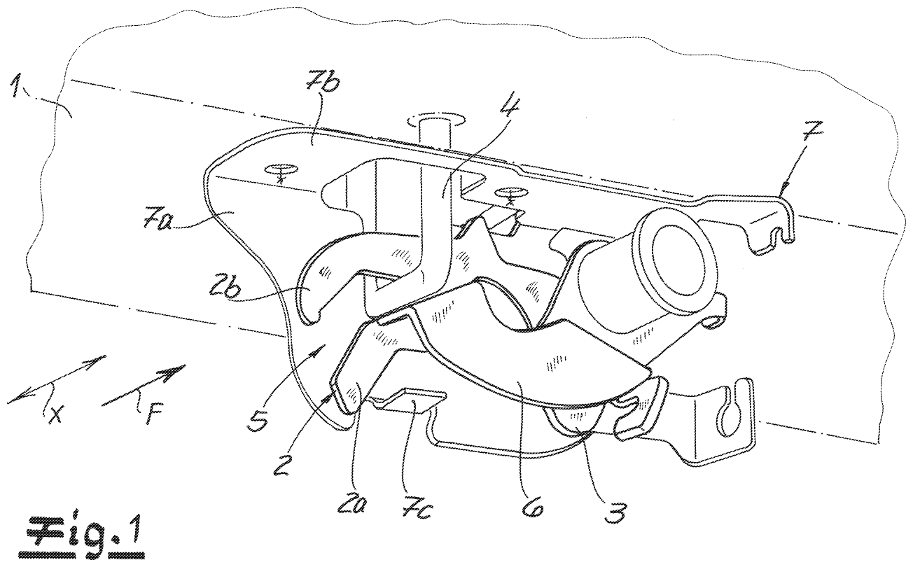

FIG. 1 shows an overview of the motor vehicle locking device according to the invention and

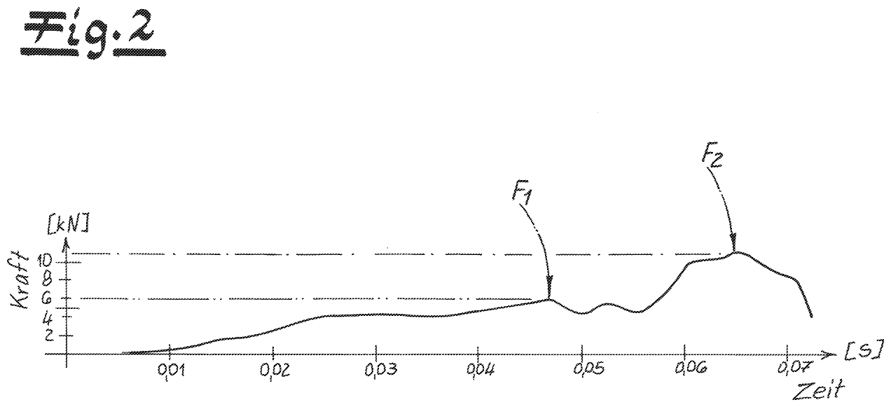

FIG. 2 shows a force-time diagram schematically, which represents the course of an accident.

FIG. 1 shows the motor vehicle locking device according to the invention, reduced to its substantial elements. In fact, FIG. 1 shows the motor vehicle locking device, which according to the embodiment example is designed as a motor vehicle lock and specifically as a motor vehicle bonnet lock. The motor vehicle bonnet lock shown in FIG. 1 makes it possible to lock a hood 1 of a motor vehicle, which is only indicated here, and to keep it closed in the closed position of an associated locking mechanism 2, 3. For this purpose, the front hood 1 has a locking bolt 4, which is held in an inlet mouth 5 of the rotary latch 2 when the locking mechanism 2, 3 is in the closed position shown in FIG. 1.

In fact, the inlet mouth 5 of the rotary latch 2 is formed by the rotary latch 2 being fork-shaped and equipped with a stop leg 2a and a catch leg 2b. In addition, an ejector element 6 can be seen, which is of no particular significance for the following considerations. The ejector element 6 is mounted on the same axis as the pawl 3. In contrast, the rotary latch 2 has a bearing spaced apart from this. In both cases, the bearing is provided by respective bearing pins, which are anchored in a lock case 7 bearing the locking mechanism 2, 3.

The lock case 7 is designed to be deformable in response to forces F that are acting thereon and those caused by acceleration, for example in the event of a crash. The forces F in question are those that correspond to a frontal impact as shown in FIG. 1 and are exemplary, i.e. they run in the longitudinal direction X of a motor vehicle as indicated there.

It can be seen that the lock case 7 is L-shaped with a long L-leg 7a and a short L-leg 7b in the embodiment example and in cross-section. The long L-leg 7a defines an impact plate of the lock case 7. It can also be seen that the locking mechanisms 2, 3 (and also the ejector element 6) are mounted on the long L-leg 7a or the impact plate provided at this point. In contrast, the short L-leg 7b and the fastening plate realized at this point serve to fix the lock case 7 to a cross beam of a motor vehicle not shown in detail, which is only indicated in FIG. 1.

If the frontal impact indicated in FIG. 1 now occurs and the force F acts on the motor vehicle bonnet lock shown in the drawing, the force F in the locking position of the locking mechanism 2, 3 shown ensures that the locking mechanism 2, 3 is deformed. This is because the force F acts on the locking bolt 4 and ensures that tearing forces act on the bearing pins of the locking mechanism 2, 3, which attempt to tear one or both bearing pins out of the lock case 7. The locking mechanism 2, 3 in conjunction with the bearing pins counteracts this with a corresponding moment of resistance.

A time curve of the relevant force F is shown in the diagram in FIG. 2. It can be seen that up to a first force limit F₁, the locking mechanism 2, 3 is increasingly deformed. In the region of this force limit F₁, the lock case 7 is also deformed as a whole by the applied force F. This applies in particular to the long L-leg 7a, which defines the impact plate. This means that from a certain force F, which may lie in the region of the first force limit F₁ indicated in FIG. 2, the lock case 7 is increasingly deformed, namely in the direction of the locking mechanism 2, 3.

As a result of this, the deformed lock case 7 now increasingly comes into contact with the locking mechanism 2, 3 from the force in question to increase a common moment of resistance. This means that the deformation of the lock case 7 corresponds to the fact that a distance required in normal operation between the lock case 7 or the long L-leg 7a and the locking mechanism 2, 3 is increasingly bridged by the deformation of the lock case 7 and in particular the long L-leg 7a.

In this manner, the deformed lock case 7 is applied to the locking mechanism 2, 3 and specifically the rotary latch 2, with increasing force F. As a result, the locking mechanism 2, 3 is stiffened by the combinatorial effect together with the deformed lock case 7. The overall design is such that the locking mechanism 2, 3 can be deformed up to the first force limit F₁ and, together with the lock case 7, which can also be deformed, reaches a higher second force limit F₂, as can be seen directly from the force/time diagram in FIG. 2. This also shows that the first force limit F₁ is located at approx. 4 to 6 kN, whereas for the second force limit F₂ values of more than 9 kN to approx. 12 kN are observed.

As a result, the joint deformability of the locking mechanism 2, 3 in contact with the lock case 7 and the lock case 7 leads to an increase in the force F resulting from the frontal impact by at least 50% compared to the situation where the locking mechanism 2, 3 is used to absorb the force alone.

For this purpose, the design is also such that the lock case 7 or its long L-leg 7a and the rotary latch 2 overlap in a top view to increase the joint moment of resistance. In addition, the lock case 7 has at least one guide element 7c which serves to guide the deformable lock case 7 and the locking mechanism 2, 3 towards one another. According to the embodiment example, the guide element 7c of the lock case 7 in question is a folded edge 7c on the metal lock case 7, which can therefore be produced particularly quickly and cost-effectively. In addition, the design is such that the guide element or the folded edge 7c engages over the stop leg 2a of the rotary latch 2.

In this manner, it is not only ensured that the lock case 7 or its long L-leg 7a is guided relative to the rotary latch 2 when it is deformed as a result of the force F acting on it. At the same time, this design ensures that the rotary latch 2 and the pawl 3 continue to engage with each other unchanged, even when the second force limit F₂ is reached, and that the locking position adopted from the outset is therefore maintained. This also prevents the front hood 1 from opening unintentionally because the closed locking mechanism 2, 3 continues to hold the locking bolt 4 in its inlet mouth 5.

### LIST OF REFERENCE SIGNS

1 front hood
2 rotary latch
2a stop leg
2b catch leg
3 pawl
2, 3 locking mechanisms
4 locking bolt
5 inlet mouth
6 ejector element
7 lock case
7a long L-leg
7b short L-leg
7c guide element/folded edge
F forces
F₁ first force limit
F₂ second force limit
X longitudinal direction

1. A motor vehicle locking device comprising:
a locking mechanism including a rotary latch and a pawl, and
a lock case for mounting the locking mechanism, wherein the lock case is deformable in response to an acceleration-induced force, and wherein when the acceleration-induced force is above a certain force the lock case deforms to rest against the locking mechanism to increase a common moment of resistance of the locking mechanism and the lock case.

2. The motor vehicle locking device according to claim 1, wherein the locking mechanism is deformed up to a first force limit of the acceleration-induced force, and the locking mechanism and the lock case deform together when the acceleration-induced force reaches a second force limit that is higher relative to the first force limit.

3. The motor vehicle locking device according to claim 2, wherein the first force limit is from 4 to 6 kN.

4. The motor vehicle locking device according to claim 2, wherein the second force limit is from 9 kN to 12 kN.

5. The motor vehicle locking device according to claim 1, wherein a force absorption of joint deformation of the locking mechanism in contact with the lock case and the lock case corresponds to an increase in absorbable force of at least 50% compared to a force absorption by deformation of the locking mechanism alone.

6. The motor vehicle locking device according to claim 1, wherein the lock case and the rotary latch overlap in top view such that the lock case deforms to contact the rotary latch to increase the common moment of resistance.

7. The motor vehicle locking device according to claim 6, wherein the lock case is equipped with at least one guide element for mutual guidance relative to the rotary latch in the event of the deformations of the locking mechanism and the lock case.

8. The motor vehicle locking device according to claim 7, wherein the at least one guide element is designed as a folded edge on the lock case.

9. The motor vehicle locking device according to claim 7, wherein the at least one guide element engages over a stop leg of the rotary latch.

10. The motor vehicle locking device according to claim 1, wherein the lock case is L-shaped in cross-section with a long L-leg and a short L-leg, wherein the long L-leg defines a deformable impact plate extending transversely to a longitudinal extension of a motor vehicle and the short L-leg defines a mounting plate coupled to a cross beam of the motor vehicle.

11. The motor vehicle locking device according to claim 10, wherein the locking mechanism is mounted on the long L-leg of the lock case.

12. The motor vehicle locking device according to claim 10, wherein the long L-leg of the lock case and the rotary latch overlap in top view such that the long L-leg of the lock case deforms to contact the rotary latch to increase the common moment of resistance.

13. The motor vehicle locking device according to claim 1, wherein the locking mechanism further includes bearing pins that provide the moment of resistance for the locking mechanism.
